(19) United States
(12) Patent Application Publication
(10) Pub. No.: US 2007/0164945 A1
(43) Pub. Date: Jul. 19, 2007

(54) Display apparatus and control method thereof

(75) Inventor: Jung-min Jung, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/651,569

(22) Filed: Jan. 10, 2007

(30) Foreign Application Priority Data
Jan. 13, 2006 (KR) 10-2006-0004120

(51) Int. Cl. G09G 3/34

(52) U.S. Cl. 345/84

(57) ABSTRACT

A display apparatus comprises a light source which sequentially emits light of a plurality of colors, a display part which selectively projects the light emitted from the light source and displays an image, a data storage which stores a plurality of waveform data for representing a ratio of the plurality of colors, a light source driver which controls a strength of the light emitted from the light source, and a controller which selects a waveform data from the plurality of waveform data and controls the light source driver to control the strength of the light based on the selected waveform data.

### CROSS-REFERENCE TO RELATED APPLICATIONS

This application claims priority from Korean Patent Application No. 10-2006-0004120, filed on Jan. 13, 2006 in the Korean Intellectual Property Office, the disclosure of which is incorporated herein in its entirety by reference.

### BACKGROUND OF INVENTION

1. Field of Invention

The present invention relates to a display apparatus and a control method thereof, and more particularly, to a display apparatus which displays an image based on a video signal by selectively projecting light, and a control method thereof.

2. Description of the Related Art

A display apparatus, such as a digital light processing (DLP) projection television (TV) system, a projector, etc., includes a display part equipped with a digital micromirror device (DMD) for displaying an image based on a video signal, a light source (e.g., alternating current lamp) for emitting light to the display part, a light source driver for driving the light source, and a power supply for supplying power to the light source driver.

The light source sequentially emits light of red, green, and blue colors to micro-mirrors of the DMD. The display part selectively projects incident light to a screen by turning on/off the micro-mirrors of the DMD to display an image. The light source driver receives power from the power source and provides a current having certain intensity to the light source. Light emission power of a lamp corresponds to the intensity of the current flown into the lamp, and accordingly, the light source driver controls the strength of the light emitted from the light source by controlling the strength of the light emitted to the light source.

The light source driver controls the intensity of the current output to the light source on the basis of a predetermined waveform data. FIG. 1 exemplarily shows related art waveform data. The display apparatus stores a waveform data 1 as shown in FIG. 1 in a memory and drives the light source based on the waveform data.

User's preference for a color in an image may vary, and a certain user may prefer to emphasize a specific color in the image. In this case, a related art display apparatus selectively projects red, green, and blue colors by controlling the micro-mirror of a DMD to emphasize a user's preferred color. At this time, light of a certain color which is not projected to the screen becomes energy loss.

However, a light loss of a certain color is unavoidable when light is indiscriminately emitted in accordance with a waveform data in the related art display apparatus, thereby decreasing energy efficiency.

### SUMMARY OF THE INVENTION

The present invention provides a display apparatus improving energy efficiency by controlling light emission power in accordance with a plurality of waveform data, and a control method thereof.

The present invention also provides a display apparatus optimized for an individual system by selecting a different waveform according to characteristics, purposes, and specifications of the system and emitting light, and a control method thereof.

According to an aspect of the present invention, there is provided a display apparatus comprising a light source which sequentially emits light of a plurality of colors, a display part which selectively projects the light emitted from the light source and displays an image, a data storage which stores a plurality of waveform data for representing a ratio of the plurality of colors, a light source driver which controls the strength of the light emitted from the light source, and a controller which selects a waveform data from the plurality of waveform data and controls the light source driver to control the light strength on the basis of the selected waveform data.

According to another aspect of the present invention, the display apparatus further comprises a user input part which receives information on a user's preferred color, wherein the controller determines the ratio of the plurality of colors based on the inputted information on the user's preferred color, and selects the waveform data corresponding to the determined color ratio from the plurality of waveform data.

According to another aspect of the present invention, the waveform data comprises intensity of a current for each of the plurality of colors.

According to another aspect of the present invention, the plurality of colors comprises red, green, and blue colors.

According to another aspect of the present invention, the light source comprises an alternate current lamp.

According to another aspect of the present invention, the display part comprises a digital micromirror device (DMD).

According to an aspect of the present invention, there is provided a control method of a display apparatus having a light source which sequentially emits light of a plurality of colors and a display part which selectively projects the light emitted from the light source and displays an image, the method comprising selecting a waveform data from a plurality of waveform data that represent a ratio of the plurality of colors, and controlling the strength of the light emitted from the light source in accordance with the selected waveform data.

According to another aspect of the present invention, the method further comprises receiving information on a user's preferred color, and determining the ratio of the plurality of colors on the basis of the inputted information on the user's preferred color, wherein the selecting of the waveform data comprises selecting the waveform data corresponding to the determined color ratio from the plurality of waveform data.

According to another aspect of the present invention, the waveform data comprises information on intensity of a current corresponding to each of the plurality of colors.

### BRIEF DESCRIPTION OF THE DRAWINGS

The above and/or other aspects of the prevent invention will become apparent and more readily appreciated from the following description of exemplary embodiments, taken in conjunction with the accompany drawings, in which:

FIG. 1 illustrates waveform data of a related art display apparatus;

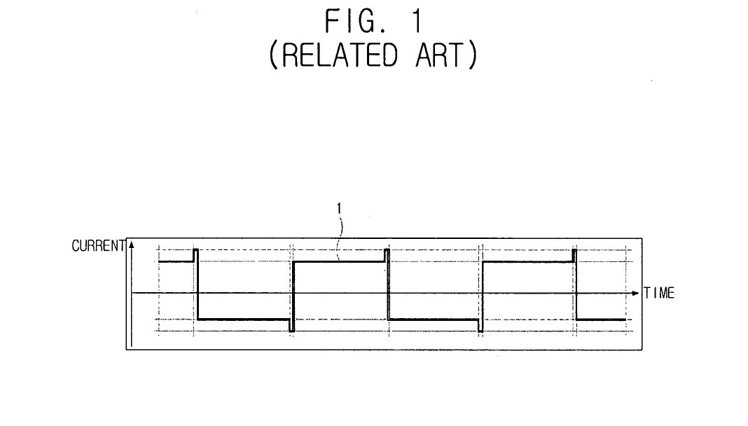

FIG. 2 is a block diagram illustrating a configuration of a display apparatus according to an exemplary embodiment of the present invention;

FIG. 3 illustrates a plurality of waveform data according to the exemplary embodiment of the present invention; and

FIG. 4 is a flowchart illustrating an operation of the display apparatus according to the exemplary embodiment of the present invention.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to like elements throughout. The embodiments are described below so as to explain the present invention by referring to the figures.

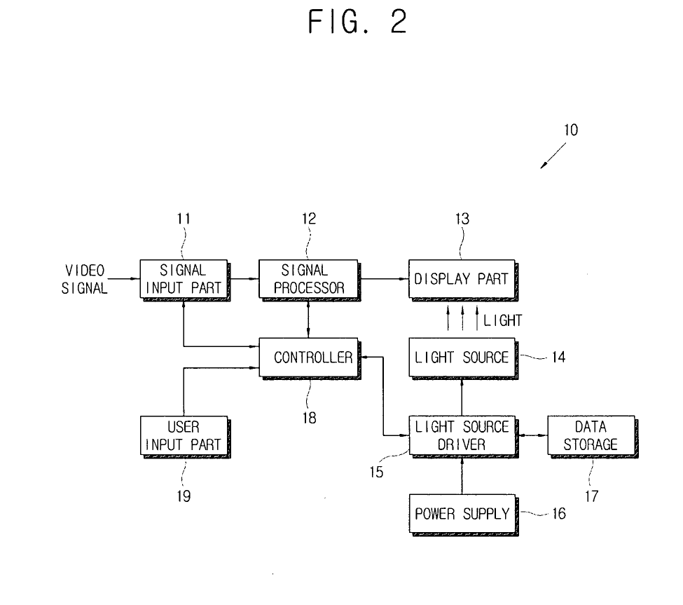

Hereinafter, an exemplary embodiment of the present invention will be described in detail with reference to the accompanying drawings. FIG. 2 is a block diagram showing a configuration of a display apparatus according to an exemplary embodiment of the present invention. The display apparatus 10 may comprise a DLP project TV, a projector, etc. As shown in FIG. 2, the display apparatus 10 includes a signal input part 11, a signal processor 12, a display part 13, a light source 14, a light source driver 15, a power supply 16, a data storage 17 and a controller 18.

The signal input part 11 externally receives a video signal having video information. The signal input part 11 may be provided as a tuner for receiving a broadcasting signal, or an input terminal for receiving a video signal from a visual apparatus such as a digital versatile disk (DVD) player, a video cassette recorder (VCR), etc.

The signal processor 12 processes the video signal input from the signal input part 11 to convert the video signal to be displayable on the display part 13. The signal processor 12 processes the video signal corresponding to a format thereof. For example, the signal processor 12 performs decoding for extracting video information, scaling for controlling resolution of an image, and picture enhancing for improving image quality.

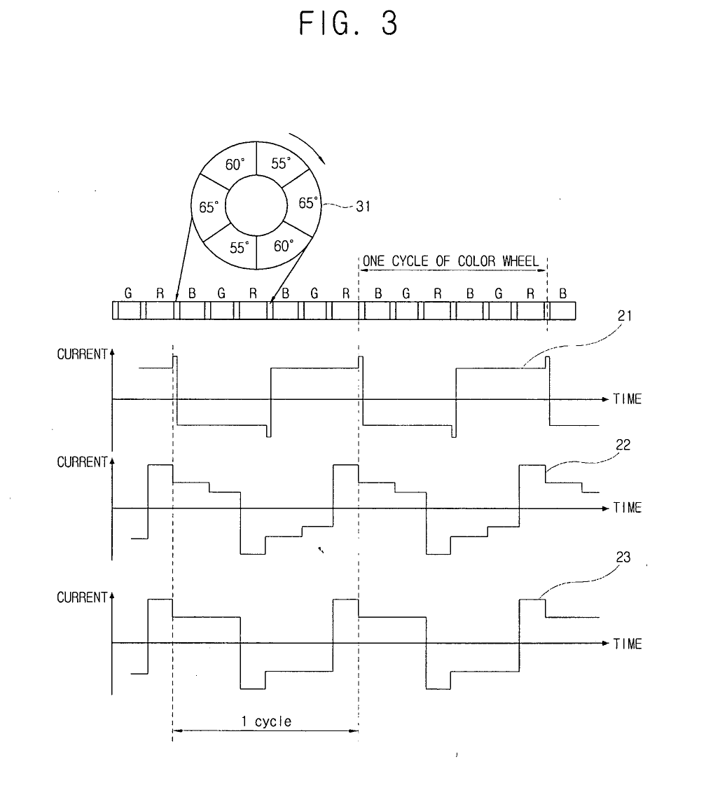

The display part 13 displays an image based on the video signal processed by the signal processor 12. The light source 14 emits light to the display part 13. The light source 14 comprises an alternate current lamp (not shown) for emitting light and a color wheel 31 (see FIG. 3) for sorting the light emitted from the alternate current lamp into light of certain colors. The light source 14 sequentially emits light of red R, green G and blue B (hereinafter, referred to as “RGB”) through the color wheel 31. In the color wheel 31, an angle corresponding to each color may be determined by using light emission time for each color.

The display part 13 includes a digital micromirror device (DMD, not shown) and a screen (not shown). The light source 14 further comprises a lens (not shown), through which the light emitted from the alternate current lamp is projected to the DMD. The display part 13 independently turns on/off several scores to millions of mirrors (not shown) integrated to the DMD on the basis of digital pixel information included in the video signal. An image displayed on the screen is formed by light projected to the mirrors of the DMD.

The light source driver 15 controls the strength of the light emitted from the light source 14. The light source driver 15 receives power from the power supply 16 and provides a current having predetermined intensity to the light source 14. The light source driver 15 controls intensity of the current based on waveform information stored in the data storage 17. The waveform information according to the exemplary embodiment of the present invention represents a ratio of each color of RGB. The data storage 17 stores a plurality of waveform data therein. The light source driver 15 reads waveform information that corresponds to a selection signal transmitted from the controller 18 and controls the intensity of current based on the read waveform information.

FIG. 3 illustrates a plurality of waveform data, that is, a first waveform data 21, a second waveform data 22 and a third waveform data 23, which are respectively stored in the data storage 17. As shown in FIG. 3, each waveform data 21, 22, and 23 represents intensity of currents respectively corresponding to the respective colors of RGB. According to the first waveform data 21, intensity of current for each segment of RGB is constant so that light of RGB can be emitted with a constant lamp waveform, respectively. However, according to the second waveform data 22, the intensity of current is changed in the order of R>B>G, and accordingly the light emission of the lamp maintains in the order of R>B>G According to the third waveform data 23, the intensity of the current is changed in the order of R>B=G, and accordingly the light emission of the lamp maintains in the order of R>B=G

The controller 18 selects a waveform data from among the plurality of waveform data stored in the data storage 17 in accordance with a user's instructions and transmits a selection signal that represents the selected waveform data to the light source driver 15. Thus, the display apparatus 10 further comprises a user input part 19 for receiving instructions from the user.

The controller 18 may directly receive information on a user's selection of waveform data from the plurality of waveform data through the user input part 19. According to another exemplary embodiment, the controller 18 may receive information on a user's preferred color through the user input part 19. The information on the user's preferred color in the exemplary embodiment represents a color to be emphasized when displaying an image having a certain color emphasized in accordance with a user's preference. In this instance, the controller 18 may determine an RGB color ratio on the basis of the inputted information on a preferred color and select a waveform data corresponding to the determined color ratio from among the plurality of waveform data.

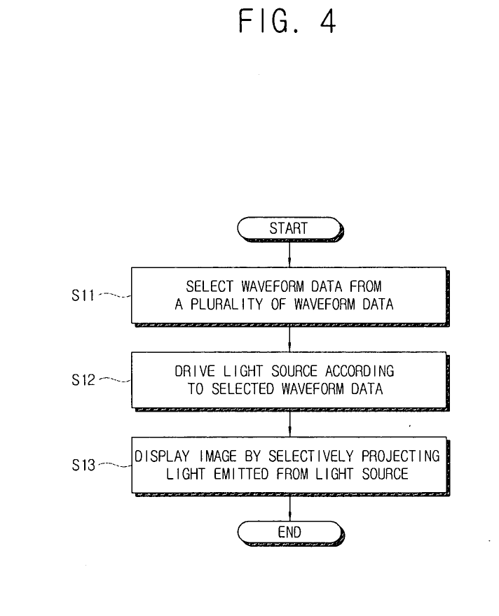

FIG. 4 is a flowchart illustrating an operation of the display apparatus according to the exemplary embodiment. The controller 18 selects a waveform data from the plurality of waveform data 21 to 23 stored in the data storage 17 in accordance with a user's instructions and transmits a selection signal that represents the selected waveform data to the light source driver 15 (S11). Next, the light source driver 15 reads a waveform data that corresponds to the transmitted selection signal from the plurality of waveform data 21 to 23 and provides a current having certain intensity to the light source 14 on the basis of the read waveform data (S12). The display part 13 selectively projects the light emitted from the light source 14 on the basis of an inputted video signal and displays an image on the screen (S13).

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display apparatus comprising:
a light source which sequentially emits light of a plurality of colors;
a display part which selectively projects the light emitted from the light source and displays an image;
a data storage which stores a plurality of waveform data for representing a ratio of the plurality of colors;
a light source driver which controls a strength of the light emitted from the light source; and
a controller which selects a waveform data from the plurality of waveform data, and controls the light source driver to control the strength of the light based on the selected waveform data.

2. The display apparatus of claim 1, further comprising a user input part which receives information on a preferred color,
wherein the controller determines the ratio of the plurality of colors based on the information on the preferred color, and selects the waveform data corresponding to the determined color ratio from the plurality of waveform data.

3. The display apparatus of claim 1, wherein the waveform data comprises an intensity of a current for each of the plurality of colors.

4. The display apparatus of claim 1, wherein the plurality of colors comprises red, green, and blue colors.

5. The display apparatus of claim 1, wherein the light source comprises an alternate current lamp.

6. The display apparatus of claim 1, wherein the display part comprises a digital micromirror device.

7. A control method of a display apparatus having a light source which sequentially emits light of a plurality of colors and a display part which selectively projects the light emitted from the light source and displays an image, the method comprising:
selecting a waveform data from a plurality of waveform data that represent a ratio of the plurality of colors; and
controlling a strength of the light emitted from the light source in accordance with the selected waveform data.

8. The method of claim 7, further comprising:
receiving information on a preferred color; and
determining the ratio of the plurality of colors based on the information on the preferred color,
wherein the selecting of the waveform data comprises selecting the waveform data corresponding to the determined color ratio from the plurality of waveform data.

9. The control method of claim 7, wherein the waveform data comprises information on an intensity of a current corresponding to each of the plurality of colors.

10. The control method of claim 7, wherein the plurality of colors comprises red, greed, and blue colors.

11. The control method of claim 7, wherein the light source comprises an alternate current lamp.

12. The control method of claim 7, wherein the display part comprises a digital micromirror device.
